(19) United States
(12) Patent Application Publication
(10) Pub. No.: US 2008/0153464 A1
(43) Pub. Date: Jun. 26, 2008

(54) METHODS AND SYSTEMS FOR INDICATING THE OCCURRENCE OF AN EVENT

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/614,222

(22) Filed: Dec. 21, 2006

(51) Int. Cl. H04M 3/537

(52) U.S. Cl. 455/412.2

(57) ABSTRACT

Accordingly, methods and systems are disclosed for indicating the occurrence of an event. According to an exemplary embodiment, a method is described for indicating the occurrence of an event. The method includes receiving a notification message including an event identifier identifying an event that has occurred. The method also includes using the event identifier to identify non-visual content for non-visual presentation associated with the event, wherein a presentation of the non-visual content indicates the occurrence of the event. The method further includes determining whether the notification message includes retention information including a deletion instruction indicating whether the notification message is to be automatically deleted in association with the presentation of the non-visual content. The method still further includes automatically deleting the received notification message in association with the presentation of the non-visual content in accordance with any deletion instruction included in the notification message.

### RELATED APPLICATIONS

The subject matter of this application is related to U.S. patent application Ser. No. 11/______, titled “METHOD AND SYSTEM FOR INDICATING THE OCCURRENCE OF AN EVENT” (Attorney Docket No. 1449/US), filed on even date with this application, the related application being commonly owned by the owner of this application, the entire disclosure of which is here incorporated by reference.

### BACKGROUND

Many events and transactions occur in the world that users would like to know about, but would be overwhelmed by phone calls and messages, such as email, for each of those events.

For example, consider the case of Mike and his mother. Mike's mother would like to know that he is home safe from school each day. Mike has to call his mother at work everyday on her mobile phone to let her know he is home from school. This is disruptive to her work since she may often be on the phone with a business associate.

Alternatively, Mike can send SMS messages indicating he is home, but this requires Mike's mother to stop what she is doing when her phone indicates that a message is received to review the message. Her mobile phone provides an indication that an SMS message has been received, but it does not tell her what the meaning or content of the message is. Mike's mother has to open her message inbox, select the message, and view it to see that Mike has arrived safely at home. Afterwards, Mike's mother must cleanup her inbox by manually deleting the message.

Accordingly, there exists a need for a method, system, and computer program product for indicating the occurrence of an event.

### SUMMARY

Accordingly, methods and systems are disclosed for indicating the occurrence of an event. According to an exemplary embodiment, a method is described for indicating the occurrence of an event. The method includes receiving a notification message including an event identifier identifying an event that has occurred. The method also includes using the event identifier to identify non-visual content for non-visual presentation associated with the event, wherein a presentation of the non-visual content indicates the occurrence of the event. The method further includes determining whether the notification message includes retention information including a deletion instruction indicating whether the notification message is to be automatically deleted in association with the presentation of the non-visual content. The method still further includes automatically deleting the received notification message in association with the presentation of the non-visual content in accordance with any deletion instruction included in the notification message.

According to another exemplary embodiment, a system is described for indicating the occurrence of an event. The system includes a communication subsystem configured to receive a notification message including an event identifier identifying an event that has occurred. The system also includes an event-content mapper component configured use the event identifier to identify non-visual content for non-visual presentation associated with the event, wherein a presentation of the non-visual content indicates the occurrence of the event. The system further includes a message handler component configured to automatically present the non-visual content to indicate the occurrence of the event. The system still further includes a trash handler component configured to determine whether the notification message includes retention information including a deletion instruction indicating whether the notification message is to be automatically deleted in association with the presentation of the non-visual content and configured to automatically delete the received notification message in association with the presentation of the non-visual content in accordance with any deletion instruction included in the notification message.

According to an exemplary embodiment, a method is described for indicating the occurrence of an event. The method includes determining whether an event has occurred. The method further includes generating a notification message including an event identifier identifying the event that has occurred and retention information including a deletion instruction indicating that the notification message is to be automatically deleted. The method also includes sending the notification message including the event identifier and the retention information including the deletion instruction, wherein the event identifier is used to identify non-visual content for non-visual presentation associated with the event, a presentation of the identified non-visual content indicates the occurrence of the event, and the deletion instruction is used to automatically delete the notification message in association with the presentation of the non-visual content.

According to another exemplary embodiment, a system is described for indicating the occurrence of an event. The system includes an event detector configured to determine whether an event has occurred. The system also includes a message generator component configured to generate a notification message including an event identifier identifying the event that has occurred and retention information including a deletion instruction indicating that the notification message is to be automatically deleted. The system also includes a communication subsystem configured to send the notification message including the event identifier and the retention information including the deletion instruction, wherein the event identifier is used to identify non-visual content for non-visual presentation associated with the event, a presentation of the identified non-visual content indicates the occurrence of the event, and the deletion instruction is used to automatically delete the notification message in association with the presentation of the non-visual content.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for indicating the occurrence of an event, according to an exemplary embodiment;

FIG. 2 illustrates a system for indicating the occurrence of an event according to an exemplary embodiment;

FIG. 3 is a flowchart illustrating a method for indicating the occurrence of an event, according to an exemplary embodiment; and

FIG. 4 is a data flow diagram illustrating the data flow in a method for indicating the occurrence of an event, according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

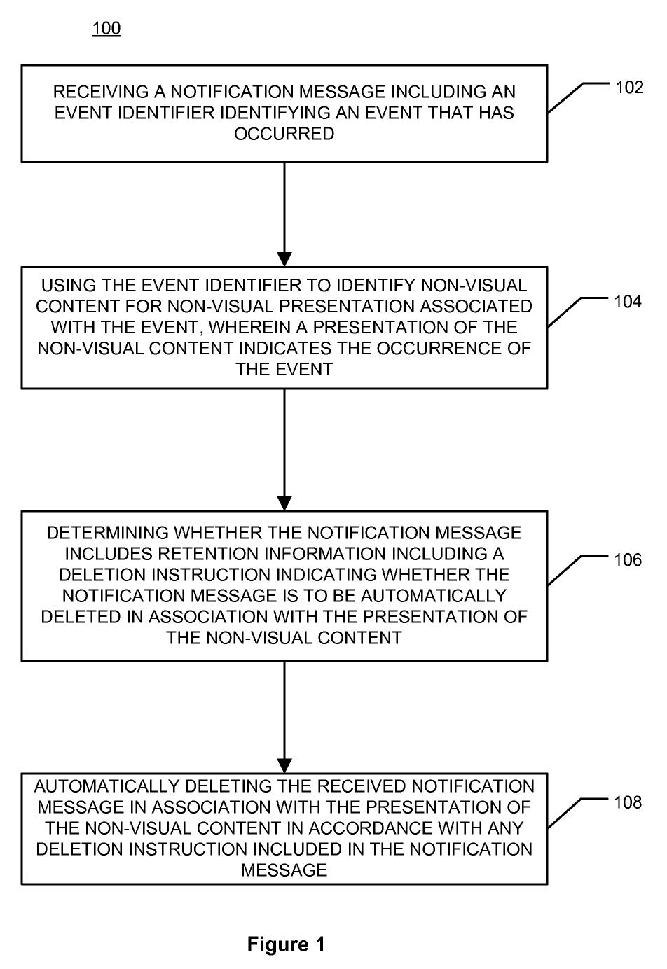

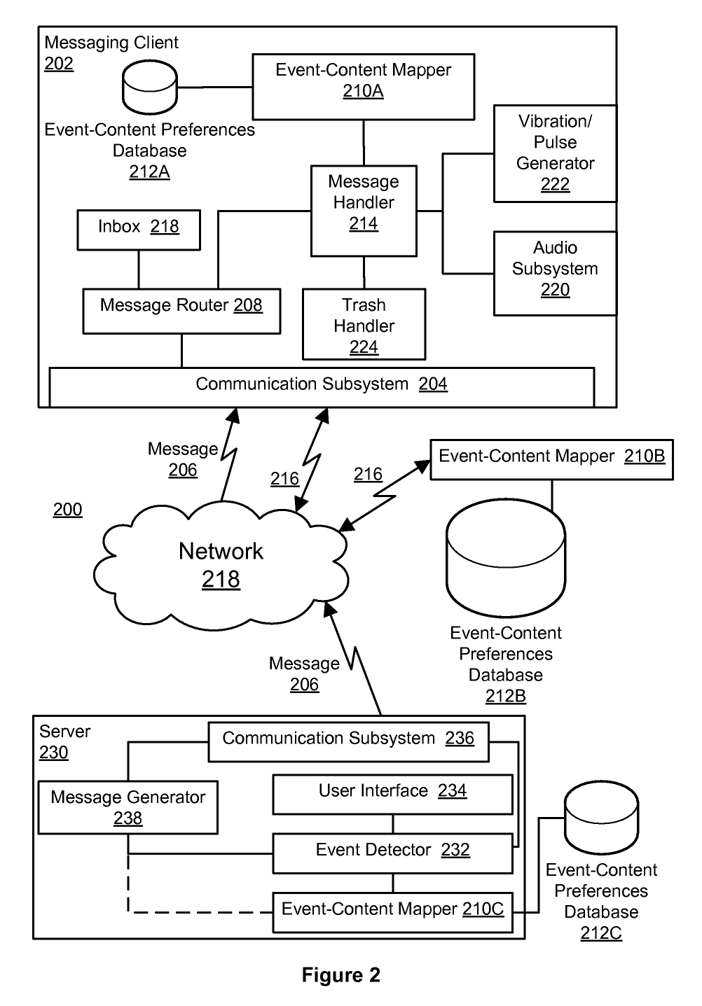

FIG. 1 depicts a flowchart illustrating an exemplary method 100 for indicating the occurrence of an event. The method can be carried out using the exemplary system 200 for indicating the occurrence of an event depicted in FIG. 2, portions of which are referenced below for illustration purposes.

FIG. 2 depicts an exemplary system 200 that includes a messaging client 202 capable of receiving notifications and a server 230 capable of providing notifications. The system 200 can be used in carrying out the method 100. The operation of the system 200 and the remaining components are described in detail with respect to performing the method 100

At block 102 of the method 100, a notification message is received, the notification message including an event identifier identifying an event that has occurred. As used herein, an event is something that happens or occurs that is capable of being detected either directly of indirectly by a networked device. Examples of events can include a change in state or mode; a creation, deletion, and/or update of an entity; a passing of control from one entity to another; and an error or fault. An event may also be an indicator of a future event, such as an event indicating the arrival of a flight at a destination within a time period indicated by the event. As used herein, an event can include the sending of communication message from one user to another.

An exemplary system for carrying out method 100 includes means for receiving a notification message including an event identifier identifying an event that has occurred. For example, a communication subsystem 204 is configured to receive a notification message 206 including an event identifier identifying an event that has occurred.

The notification message 206 or a message based on the notification message 206 is received by a communication subsystem 204 of the messaging client 202. The event identifier included in notification message 206 can be a character string used in identifying the event that has occurred. Further, the event identifier character string can includes a uniform resource identifier corresponding to a location of non-visual content associated with the event identifier.

The notification message 206 can be any of a short message service message, a multimedia messaging service message, an email, a response to a request, and an asynchronous message. An asynchronous message is an unsolicited message, received by the messaging client 202 without a request being made by the messaging client 202. The communication subsystem 204 can be configured to receive the notification message 206 sent according to any of an short message service, an multimedia messaging service, an email service, a request/response message service, and an asynchronous message. The communication subsystem 204 processes the received message and delivers a representation of the message including the identifier of an occurrence of a particular event to a message router 208.

The message router component 208 manages messages based on at least one of a protocol associated with the transmission of the message, a format of the message, or at least a portion of the content of a message. An identifiable format can be used to transmit messages that require presentation to a recipient within a specified period of time from the transmission of the message. The messages include information that expires after the specified time period, so that further processing is of little value. Such a message is referred to as an immediate delivery message (IDM). For example purposes, the notification message 206 is an IDM and in the embodiment must be delivered in substantially real-time.

At block 104 of the method 100, the event identifier is used to identify non-visual content for non-visual presentation associated with the event, wherein a presentation of the non-visual content indicates the occurrence of the event. The exemplary system for carrying out the method 100 includes means for using the event identifier to identify non-visual content for non-visual presentation associated with the event, wherein a presentation of the non-visual content indicates the occurrence of the event.

For example, an event-content mapper component 210A is configured to use the event identifier to identify non-visual content for non-visual presentation associated with the event, wherein a presentation of the non-visual content indicates the occurrence of the event. The non-visual content can include audio content and tactile content.

When the message router 208 determines the notification message 206 is an IDM, the message router 208 sends the notification message 206 including the event identifier to a message handler component 214. The message handler component 214 then transfers control to the event-content mapper 210A. Messages not matching the format of an IDM can be routed to an inbox 218 of the messaging client allowing the recipient to view and/or read the messages at the recipient's choosing.

The event-content mapper 210A can be configured to use an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event to identify the non-visual content.

The event-content mapper 210A can be configured to use an associated event-content preferences database 212A including the associations discussed above to identify non-visual content associated with the event identifier. Alternatively, the message handler component 214 can be configured to initiate a request-response communication, depicted as a communication 216 in the system 200, with a remote event-content mapper 210B service that uses an associated event-content preferences database 212B to identify non-visual content associated with an event identifier. In either case, the event content handler 210A then returns the identified non-visual content for to the message handler component 214.

Once the non-visual content has been returned, the message handler component 214 is configured to automatically present the non-visual content. The message handler component 214 determines the type of non-visual content. Presenting the non-visual content can include any of playing audio content through an audio subsystem 220 and generating a movement of a physical element through a vibration/pulse generator 222.The messaging client 202 in the system 200 includes a vibration/pulse generator 222 capable of causing the physical housing of the messaging client to vibrate at a specified rate, a specified strength, and/or a specified pattern, and capable of causing the physical housing to pulse at a specified rate, a specified strength, and/or a specified pattern.

Alternatively, the message router component 208 can be configured to determine whether the received notification message excludes visual information for non-visual presentation that identifies the occurrence of the event. The message handler component 214 can be configured to automatically present the non-visual content to indicate the occurrence of the event when the message router 208 determines the notification message 206 excludes visual information that identifies the occurrence of the event.

At block 106 of the method 100, it is determined whether the notification message 206 includes retention information including a deletion instruction indicating whether the notification message 206 is to be automatically deleted in association with the presentation of the non-visual content. The exemplary system for carrying out method 100 includes means for determining whether the notification message 206 includes retention information including a deletion instruction indicating whether the notification message 206 is to be automatically deleted in association with the presentation of the non-visual content.

For example, a trash handler component 224 is configured to determine whether the notification message 206 includes retention information including a deletion instruction indicating whether the notification message 206 is to be automatically deleted in association with the presentation of the non-visual content.

Retention information as used herein is information included in a message that affects the storage of a message received by a device. The retention information can cause a notification message to be deleted in association with the presenting of the non-visual content. The retention information included in a notification message can be a command code or a representation of an instruction such as a script or a declarative element such as an XML element and/or attribute that a receiver of the message uses in determining whether to retain a message, where to retain it, and/or in what format to retain it. The information used by the message router 208 to determine that a message is an IDM may also be used as the retention information. Similarly, the retention information may be used by the message router 208 to determine that a message is an IDM.

The retention information included in the notification message 206 can include a retention period defining a period from a time of receipt of the notification message, after which, the notification message 206 is to be automatically deleted. The retention information can include a deletion instruction causing the notification message is to be automatically deleted in association with the presentation of the non-visual content. The deletion instruction may be a command code or a representation of an instruction such as a script that a receiver of the message uses in determining whether to retain a message, where to retain it, and/or in what format to retain it

The deletion instruction can be included in the notification message 206 when the notification message excludes visual information for visual presentation that identifies the occurrence of the event. This allows the automatic deletion of the notification message after the non-visual content is automatically presented to indicate the occurrence of the event.

The retention information can include a retention period defining a period from a time of receipt of the notification message 206, after which, the notification message is to be automatically deleted by the trash handler component 224. The retention period allows for automatic deletion of un-played messages that are associated with information that is transient in nature. The retention period ensures that out-of-date notifications are not presented.

At block 108 of the method 100, the received notification message 206 is automatically deleted in association with the presentation of the non-visual content in accordance with any deletion instruction included in the notification message 206. The exemplary system for carrying out method 100 includes means for automatically deleting the received notification message in association with the presentation of the non-visual content in accordance with any deletion instruction included in the notification message.

For example, the trash handler component 224 is configured to automatically delete the received notification message in association with the presentation of the non-visual content in accordance with any deletion instruction included in the notification message

The message handler component 214 invokes the trash handler component 224 that deletes the notification message 206 automatically in association with the presentation of the identified non-visual content according to a deletion instruction in the notification message 206.

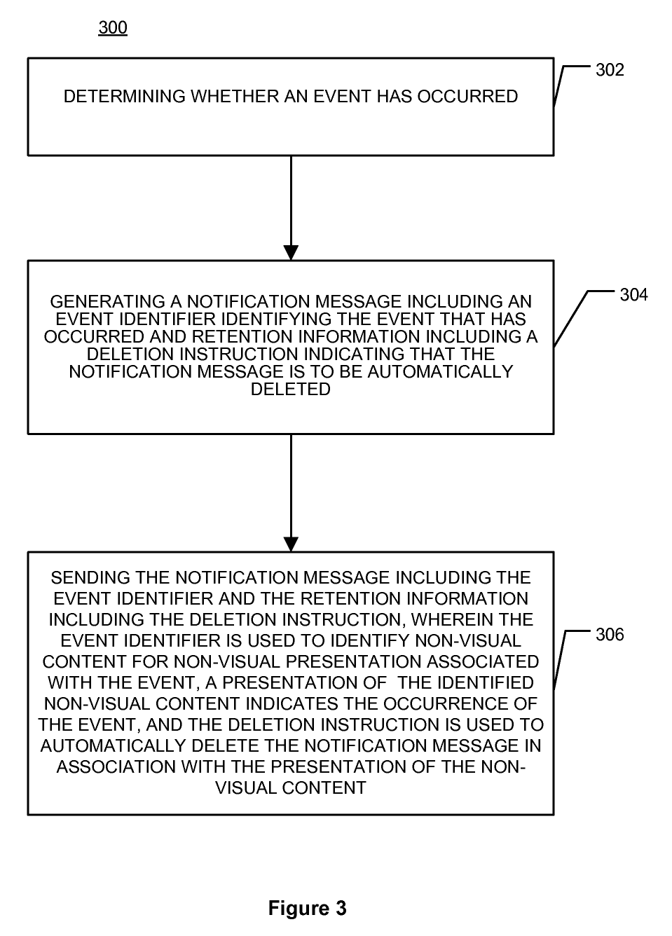

FIG. 3 depicts a flowchart illustrating an exemplary method 300 for indicating the occurrence of an event. The method can be carried out using the exemplary system 200 for indicating the occurrence of an event depicted in FIG. 2, portions of which are referenced below for illustration purposes.

At block 302 of the method 300, it is determined whether an event has occurred. A system for carrying out the method 300 includes an event detector 232 configured to determine whether an event has occurred.

For example, in the system 200 the server 230 can receive information via a user interface 234 and/or by an interface provided by a communication subsystem 236 where the information is associated with a notification. The received information is received by and processed as an event occurrence by an event detector 232.

The event detector 232 can be configured to determine a recipient of the notification message 206. For example, the event detector 232 can identify a recipient or an agent of a recipient, such as the messaging client 202 of a recipient. The event detector 232 invokes a message generator 238 for generating a notification message indicating the occurrence of an event, including a corresponding event identifier identifying the detected event, to the identified recipient.

At block 304 of the method 300, a notification message is generated. The notification message including an event identifier identifying the event that has occurred and retention information including a deletion instruction indicating that the notification message is to be automatically deleted.

The system for carrying out the method 300 includes a message generator component 238 configured to generate a notification message including an event identifier identifying the event that has occurred and retention information including a deletion instruction indicating that the notification message is to be automatically deleted.

The message generator 238 creates a message 206 including the event identifier according to a specified messaging protocol. Examples of messaging protocols have been previously described. The message generator 238 creates the notification message including the event identifier. The message generator 238 provides the message to the communication subsystem 236 for transmitting via the network 218 to the agent, the messaging client 202, of the identified recipient.

The message generator 238 is configured to include retention information in the notification message. The message generator 238 can be configured to include a deletion instruction as part of the retention information in the notification message. The message generator 238 can be configured to do so when the notification message excludes visual information for visual presentation that identifies the occurrence of the event. This allows the automatic deletion of the notification message 206 after the non-visual content is automatically presented to indicate the occurrence of the event. Further the message generator 238 can be configured to include a retention period in the notification message for defining a period from a time of receipt of the notification message, after which, the notification message is to be automatically deleted.

The server 230, in one case, includes an event-content mapper 210C and an associated event-content preferences database 212C to identify non-visual content for non-visual presentation associated with a particular event. The non-visual content is then sent to the recipient as part of the notification message.

At block 306 of the method 300, the notification message 206 is sent including the event identifier and the retention information including the deletion instruction, wherein the event identifier is used to identify non-visual content for non-visual presentation associated with the event, a presentation of the identified non-visual content indicates the occurrence of the event, and the deletion instruction is used to automatically delete the notification message 206 in association with the presentation of the non-visual content.

The system for carrying out the method 300 includes a communication subsystem configured to send the notification message 206 including the event identifier and the retention information including the deletion instruction. Once received, the event identifier is used to identify non-visual content associated with the event. A presentation of the identified non-visual content indicates the occurrence of the event. The deletion instruction is used to automatically delete the notification message 206 in association with the presentation of the non-visual content.

Various forms of message delivery mechanisms are describe above, and all are capable of delivering the notification message 206 or a message based on the message 206 to the messaging client 202. The delivery mechanisms include proxies such as pub-sub services and presence services, request response protocols such as HTTP, remote procedure call (RPC) mechanisms, store and forward systems such as topic based publish-subscribe, email, MMS, and SMS, and any proprietary or private delivery systems.

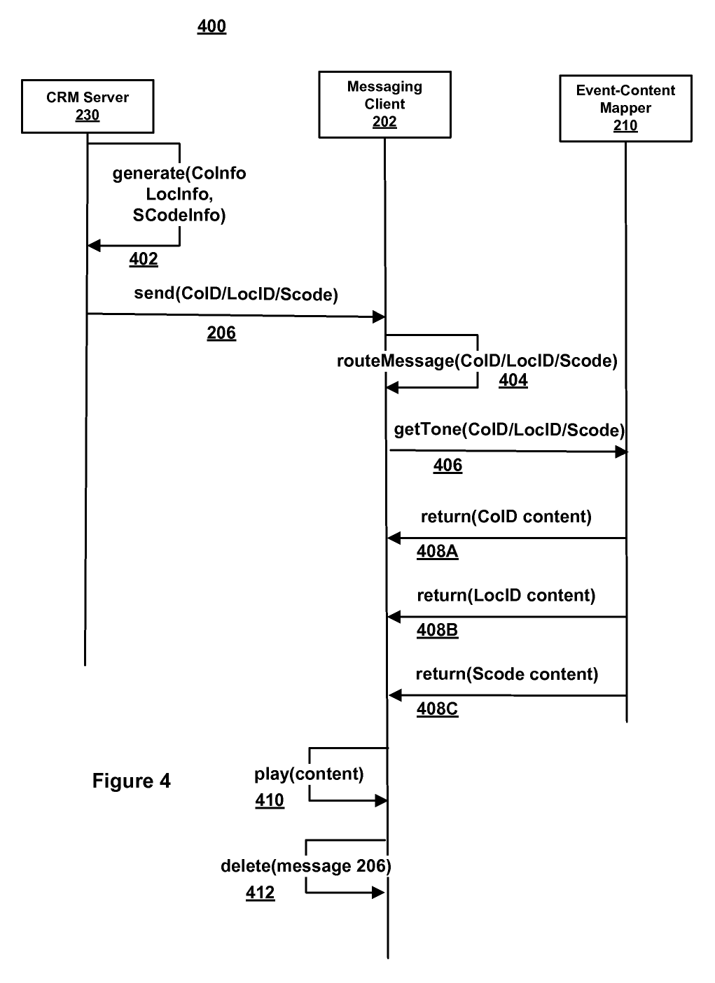

FIG. 4 depicts a message flow diagram 400 illustrating an exemplary message flow between the server 230, the messaging client 202, and at least one of the event-content mappers 210A, 210B, and 210C in the system 200 operating to perform the methods 100 and 300.

The message 402 depicts an internally generated and received message of the server 230 that is processed by the message generator 238 resulting in the generation of the notification message 206 described earlier. The message 402 includes company information, location information, and service code information received from the Acme Company. The generated message 206 includes an identifier depicted as “CoID/LocID/Scode” where “CoID” corresponds to at least a portion of the identifier for identifying Acme, “LocID” corresponds to at least a portion of the identifier for identifying the Acme location on 4^{th} Street, and “Scode” corresponds to at least a portion of the identifier for identifying the service code indicating a fatal error in a mail server.

The message 206 is sent from the server 230 and is received by the messaging client 202 using a communication subsystem previously described. The messaging client 202 message router 208 identifies the message 206 as an IDM and routes the message 206 to the message handler 214 as depicted by a routeMessage message 404 in the flow diagram 400. The getTone message 406 including the event identifier included in the message 206 is sent to at least one of the depicted and described event-content mappers 210A 210B 210C. The event-content mapper 210 uses an associated event-content preferences database 212 to identify non-visual content for non-visual presentation associated with each of the three portions of the identifier of the message 206. As a result the event-content mapper 210 sends return messages 408A 408B 408C corresponding to each portion of the identifier where each return message includes non-visual content identified for each portion of the identifier. The messaging client message handler 214 provides the non-visual content received in the return messages 408A 408B 408C in a play message 410 that when processed corresponds to the message handler 214 invoking the audio subsystem 220 to present the returned non-visual audio content to the recipient automatically. When the non-visual content is presented, the message 206 is automatically deleted as depicted by the delete message 412 generated by the message handler 214 and processed by the trash handler 224.

The executable instructions of a computer program as illustrated in FIGS. 1 and 3 for indicating the occurrence of an event can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for indicating the occurrence of an event, the method comprising:
receiving a notification message including an event identifier identifying an event that has occurred;
using the event identifier to identify non-visual content for non-visual presentation associated with the event, wherein a presentation of the non-visual content indicates the occurrence of the event;
determining whether the notification message includes retention information including a deletion instruction indicating whether the notification message is to be automatically deleted in association with the presentation of the non-visual content; and
automatically deleting the received notification message in association with the presentation of the non-visual content in accordance with any deletion instruction included in the notification message.

2. The method of claim 1, wherein the event identifier includes a character string used in identifying the event that has occurred.

3. The method of claim 2, wherein the event identifier character string includes a uniform resource identifier corresponding to a location of the non-visual content.

4. The method of claim 1, wherein the notification message is at least one of a short message service message, a multimedia messaging service message, an email, a response to a request, and an asynchronous message.

5. The method of claim 1, wherein identifying non-visual content associated with the occurrence of the event is based on an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event.

6. The method of claim 1, wherein the non-visual content includes at least one of audio content and tactile content.

7. The method of claim 6, comprising automatically presenting the non-visual content including at least one of playing audio content and generating a movement of a physical element.

8. The method of claim 1, wherein the deletion instruction is included in the notification message when the notification message excludes visual information for visual presentation that identifies the occurrence of the event, allowing the automatic deletion of the notification message after the non-visual content is automatically presented to indicate the occurrence of the event.

9. The method of claim 1, wherein the retention information includes a retention period defining a period after the occurrence of the event, after which, the notification message is to be automatically deleted.

10. The method of claim 1, wherein the identified non-visual content is automatically presented to indicate the occurrence of the event when the notification message excludes visual information that identifies the occurrence of the event.

11. A system for indicating the occurrence of an event, the system comprising:
a communication subsystem configured to receive a notification message including an event identifier identifying an event that has occurred;
an event-content mapper component configured use the event identifier to identify non-visual content for non-visual presentation associated with the event, wherein a presentation of the non-visual content indicates the occurrence of the event;
a message handler component configured to automatically present the non-visual content to indicate the occurrence of the event; and
a trash handler component configured to determine whether the notification message includes retention information including a deletion instruction indicating whether the notification message is to be automatically deleted in association with the presentation of the non-visual content and configured to automatically delete the received notification message in association with the presentation of the non-visual content in accordance with any deletion instruction included in the notification message.

12. The system of claim 11, wherein the event identifier includes a character string used in identifying the event that has occurred.

13. The system of claim 12, wherein the event identifier character string includes a uniform resource identifier corresponding to a location of the non-visual content.

14. The system of claim 11, wherein the communication subsystem is configured to receive the notification message sent according to at least one of an short message service, an multimedia messaging service, an email service, a request/response message service, and an asynchronous message service.

15. The system of claim 11, wherein the event-content mapper component is configured to identify non-visual content associated with the occurrence of the event is based on an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event.

16. The system of claim 11, wherein the non-visual content includes at least one of audio content and tactile content.

17. The system of claim 16, wherein the message handler component is configured to automatically present the non-visual content by at least one of playing audio content and generating a movement of a physical element.

18. The system of claim 11, wherein the deletion instruction is included in the notification message when the notification message excludes visual information for visual presentation that identifies the occurrence of the event, allowing the automatic deletion of the notification message after the non-visual content is automatically presented to indicate the occurrence of the event.

19. The system of claim 11, wherein the retention information includes a retention period defining a period after the occurrence of the event, after which, the notification message is to be automatically deleted.

20. The system of claim 11, comprising:
a message router component configured to determine whether the received notification message excludes visual information for visual presentation that identifies the occurrence of the event;
wherein the message handler component is configured to automatically present the non-visual content to indicate the occurrence of the event when the message router determines the notification message excludes visual information for visual presentation that identifies the occurrence of the event.

21. A computer readable medium containing a computer program, executable by a machine, for indicating the occurrence of an event, the computer program comprising executable instructions for:
receiving a notification message including an event identifier identifying an event that has occurred;
using the event identifier to identify non-visual content for non-visual presentation associated with the occurrence of the event, wherein a presentation of the non-visual content indicates the occurrence of the event;
determining whether the notification message includes retention information including a deletion instruction indicating whether the notification message is to be automatically deleted in association with the presentation of the non-visual content; and
automatically deleting the received notification message in association with the presentation of the non-visual content in accordance with any deletion instruction included in the notification message.

22. A system for indicating the occurrence of an event, the system comprising:
means for receiving a notification message including an event identifier identifying an event that has occurred;
means for using the event identifier to identify non-visual content for non-visual presentation associated with the occurrence of the event, wherein a presentation of the non-visual content indicates the occurrence of the event;
means for automatically presenting the non-visual content to indicate the occurrence of the event;
means for determining whether the notification message includes retention information including a deletion instruction indicating whether the notification message is to be automatically deleted in association with the presentation of the non-visual content; and
means for automatically deleting the received notification message in association with the presentation of the non-visual content in accordance with any deletion instruction included in the notification message.

23. A method for indicating the occurrence of an event, the method comprising:
determining whether an event has occurred;
generating a notification message including an event identifier identifying the event that has occurred and retention information including a deletion instruction indicating that the notification message is to be automatically deleted; and
sending the notification message including the event identifier and the retention information including the deletion instruction, wherein the event identifier is used to identify non-visual content for non-visual presentation associated with the event, a presentation of the identified non-visual content indicates the occurrence of the event, and the deletion instruction is used to automatically delete the notification message in association with the presentation of the non-visual content.

24. The method of claim 23, comprising determining a recipient of the notification message.

25. The method of claim 23, wherein the deletion instruction is included in the notification message when the notification message excludes visual information for visual presentation that identifies the occurrence of the event, allowing the automatic deletion of the notification message after the non-visual content is automatically presented to indicate the occurrence of the event.

26. The method of claim 23, wherein generating the notification message including the retention information comprises including a retention period in the notification message for defining a period from a time of receipt of the notification message, after which, the notification message is to be automatically deleted.

27. A system for indicating the occurrence of an event, the system comprising:
an event detector configured to determine whether an event has occurred;
a message generator component configured to generate a notification message including an event identifier identifying the event that has occurred and retention information including a deletion instruction indicating that the notification message is to be automatically deleted; and
a communication subsystem configured to send the notification message including the event identifier and the retention information including the deletion instruction, wherein the event identifier is used to identify non-visual content for non-visual presentation associated with the event, a presentation of the identified non-visual content indicates the occurrence of the event, and the deletion instruction is used to automatically delete the notification message in association with the presentation of the non-visual content.

28. The system of claim 27, wherein the event detector is configured to determine a recipient of the notification message.

29. The system of claim 27, wherein the deletion instruction is included in the notification message when the notification message excludes visual information that identifies the occurrence of the event, allowing the automatic deletion of the notification message after the non-visual content is automatically presented to indicate the occurrence of the event.

30. The system of claim 27, wherein in generating the notification message including the retention information, the message generator is configured to include a retention period in the notification message for defining a period after the occurrence of the event, after which, the notification message is to be automatically deleted.
